(19) United States
(12) Patent Application Publication
(10) Pub. No.: US 2003/0235307 A1
(43) Pub. Date: Dec. 25, 2003

(54) Encryption and decryption program

(76) Inventor: Kazuhiro Miyamoto, Kanazawa-shi (JP)

Correspondence Address: Karl F. Milde, Jr., Esq., MILDE & HOFFBERG, L.L.P., Suite 460, 10 Bank Street, White Plains, NY, 10606, US

(21) Appl. No.: 10/457,628

(22) Filed: Jun. 9, 2003

(30) Foreign Application Priority Data
Jun. 13, 2002 (JP) 2002-173223

(51) Int. Cl. H04K 1/00

(52) U.S. Cl. 380/269

(57) ABSTRACT

A novel hybrid cryptosystem proposed in the present invention comprises a step of removing a part of data from a compressed message to be later encrypted with a symmetric cryptography so as to encrypt a session key and the removed data with a public key, which is an additional step that a conventional hybrid cryptosystem does not have.

### BACKGROUND OF THE INVENTION

1. Field of the Invention

The present invention relates to a method of ensuring secure message exchange between a sender and a receiver over an insecure telecommunication line, and more particularly to an encryption program for protecting a message from tampering by encrypting the message with an encryption algorithm.

2. Description of Related Art

In the history of encryption, symmetric cryptography has been used over centuries. For example, in symmetric cryptography of ancient times, only a sender and a receiver had the same key to a box so that others could not see a message in the box. In today's well-developed computer network, the symmetric cryptography is used for sending and receiving a secret message via the Internet.

In such secret message, each character is generally represented by 8-bit binary digits, so that a message body is also represented by binary digits. The message is encrypted with an encryption algorithm using a symmetric key represented by binary digits. In other words, the message is encrypted with a symmetric algorithm in which a substitution cipher and a transposition cipher are used in combination.

In a general cryptography, a message encrypted using a key of a longer length (length of the key is hereinafter referred to as “key length”) is more difficult to break. However, in a symmetric cryptography, a message can be relatively securely encrypted using a key of a relatively short length. This is the reason why a symmetric key has been widely used in the military intelligence services and other business worlds for a long time. However, too much expenses are required for a secure key transmission.

In a public-key cryptography that was developed in 1970's, an encryption algorithm is based on a mathematical function, and two types of keys associated with each user are generated using a mathematical process. One of the keys is a private key which is known only by the user, and the other is a public key which is open to the public. A sender encrypts a message with the public key, and a receiver decrypts the encrypted message with his/her private key. Unlike in the symmetric cryptography, there is no need to transmitting a key to a receiver in the public-key cryptography. Thus, the aforementioned disadvantage of the symmetric cryptography is solved by the public-key cryptography. Further, from the nature of its algorithm, the public-key cryptography also made it possible to realize a logical signature called “digital signature”.

However, in order to produce a cryptographically secure key whose encryption cannot be easily broken by attackers, a public key and a private key must be longer in length than the keys required in the symmetric cryptography. Therefore, since larger computing resources are required, the encryption and decryption speeds of the public-key cryptography are much slower than those of the symmetric cryptography.

This problem can be solved by a hybrid cryptosystem that combines the advantages of both symmetric and asymmetric cryptographic algorithms. In this cryptosystem, a symmetric key is encrypted using a public key, and then the encrypted symmetric key and a message encrypted with the symmetric key are transmitted to a receiver.

The symmetric key used in the hybrid cryptosystem is a one-time-only random key, which is also called “session key”. Where the symmetric key encryption is used alone, the symmetric key must be used a plurality of times, so that it is easy to break the encrypted message by discovering the key in a brute force attack. However, in the hybrid cryptosystem, the use of a session key makes it hard to break the encrypted message because previous decryption information is useless in the next decryption.

In this hybrid cryptosystem, it is only the key that is encrypted with the public key. Therefore, the slowness of the encryption/decryption process in a public key cryptography exerts little influence on the whole processing speed. Further, the session key is updated whenever the encrypted message is transmitted, which makes the session key cryptographically secure.

PGP (Pretty Good Privacy) is the most typical example of the hybrid cryptosystem. In PGP, a message is compressed with a compression algorithm. Such compression of the message further improves cryptographic security of the symmetric cryptography, because the compressed message is less redundant than the original message and becomes hard to break. Further, the compression of the message speeds up the transmission time of the e-mail.

In PGP, either ZIP or ZLIB is used as a compression algorithm. The deflate compression algorithm used in ZIP and ZLIB is a variation of Lempel-Ziv LZ77.

Further, in PGP, radix-64 conversion called “ASCII Armor” is used to send a ciphertext through an e-mail channel. In Radix-64 conversion, binary data is converted into ASCII characters. Actually, 6-bit values are converted into 8-bit ASCII characters, so that this conversion expands the data to about 1.33 times its original size. However, a compression algorithm mitigates this expansion.

FIG. 6 shows a cryptographic algorithm in PGP. In FIG. 6, Z represents compression means, ∥ represents combining means, Es represents symmetric-key encrypting means, Ep represents public-key encrypting means, R64 represents radix-64 conversion, a bold line represents a message flow, a dotted line represents an encryption using each key, and parentheses indicate that a block within parentheses can be omitted.

Such conventional hybrid cryptosystem is seemingly secure as far as a public key encryption is not cracked, because a session key is generated as a random number each time. Even when a message encrypted using a hybrid cryptosystem is attacked and a session key is discovered, only the message sent under that key is cracked. The discovered session key cannot be used to attack other encrypted messages. Therefore, the cracking of the full body of the message cannot be achieved unless a public key is successfully discovered.

However, if a new attacking method other than a brute force attack is found or if the brute force attack is performed at much higher speed, the symmetric key is likely to be discovered for much shorter time. Further, in the conventional hybrid encryption, the public-key encryption protects only a session key, so that the full body of a desired message can be cracked only by breaking a ciphertext encrypted with the symmetric encryption using the session key. Therefore, in order to protect a ciphertext encrypted with a hybrid cryptosystem, an attack on the ciphertext encrypted with the symmetric key cannot be disregarded.

Accordingly, an object of the present invention is to provide a novel hybrid cryptosystem in which a relation between a message to be encrypted with a symmetric key and a message encrypted with the symmetric key is not one-to-one relation and in which the message encrypted with the symmetric key cannot be cracked even if the symmetric key is found.

### SUMMARY OF THE INVENTION

A message encryption program according to the present invention causes a computer to function as: compression means for compressing binary data; combining means for combining a plurality of binary data; removing means for removing a part of data from a compression message obtained by compressing a message entered into the computer by the compression means so as to generate lacked compression message and removed data; symmetric key encryption means for encrypting the lacked compression message with a symmetric algorithm using a session key to generate an encryption message; public key encryption means for encrypting the removed data and the session key with a public key encryption algorithm using a public key by combining them by the combining means so as to generate an encryption block; and hybrid encryption means for combining the encryption message and the encryption block by the combining means to generate a hybrid encryption message.

A program for decrypting the aforementioned hybrid encryption message according to the present invention causes a computer to function as: decompression means for decompressing the binary data compressed by the compression means; decomposition means for decomposing the binary data combined by the combining means into the plurality of binary data; hybrid decryption means for decomposing the hybrid encryption message into the encryption message and the encryption block by the decomposition means; public key decryption means for decrypting the encryption block with a public key decryption algorithm using a secret key and then decomposing it into the removed data and the session key by the decomposition means; symmetric key decryption means for decrypting the encryption message into the lacked compression message with a symmetric key decryption algorithm using the session key; and embedding means for embedding the removed data in the lacked compression message to restore the compression message, wherein the compression message is decompressed by the decompression means so as to decrypt it into the message entered into the computer.

An apparatus for encrypting a message according to the present invention comprises: compression means for compressing binary data; combining means for combining a plurality of binary data; removing means for removing a part of data from a compression message obtained by compressing a message entered into the apparatus by the compression means so as to generate lacked compression message and removed data; symmetric key encryption means for encrypting the lacked compression message with a symmetric algorithm using a session key to generate an encryption message; public key encryption means for encrypting the removed data and the session key with a public key encryption algorithm using a public key by combining them by the combining means so as to generate an encryption block; and hybrid encryption means for combining the encryption message and the encryption block by the combining means to generate a hybrid encryption message.

An apparatus for decrypting the aforementioned hybrid encryption message according to the present invention comprises: decompression means for decompressing the binary data compressed by the compression means; decomposition means for decomposing the binary data combined by the combining means into the plurality of binary data; hybrid decryption means for decomposing the hybrid encryption message into the encryption message and the encryption block by the decomposition means; public key decryption means for decrypting the encryption block with a public key decryption algorithm using a secret key and then decomposing it into the removed data and the session key by the decomposition means; symmetric key decryption means for decrypting the encryption message into the lacked compression message with a symmetric key decryption algorithm using the session key; and embedding means for embedding the removed data in the lacked compression message to restore the compression message, wherein the compression message is decompressed by the decompression means so as to decrypt it into the message entered into the apparatus.

A method for encrypting a message using a computer having: compression means for compressing binary data; and combining means for combining a plurality of binary data according to the present invention, comprises the steps of: removing a part of data from a compression message obtained by compressing a message entered into the computer so as to generate lacked compression message and removed data; encrypting the lacked compression message with a symmetric algorithm using a session key to generate an encryption message; encrypting the removed data and the session key with a public key encryption algorithm using a public key by combining them by the combining means to generate an encryption block; and combining the encryption message and the encryption block by the combining means to generate a hybrid encryption message.

A method for decrypting the aforementioned hybrid encryption message using a computer having: decompression means for decompressing the binary data compressed by the compression means; and decomposition means for decomposing the binary data combined by the combining means into the plurality of binary data according to the present invention, comprises: a hybrid decryption step of decomposing the hybrid encryption message into the encryption message and the encryption block; a public key decryption step of decrypting the encryption block with a public key decryption algorithm using a secret key and then decomposing it into the removed data and the session key; a symmetric key decryption step of decrypting the encryption message into the lacked compression message with a symmetric key decryption algorithm using the session key; and an embedding step of embedding the removed data in the lacked compression message to restore the compression message, wherein the compression message is decompressed to decrypt it into the message entered into the computer.

A computer readable recording medium according to the present invention records at least the aforementioned encryption program or decryption program.

A method for ensuring secure message exchange over an insecure telecommunication line according to the present invention comprises the steps of: encrypting a message using the aforementioned message encryption method to generate an encryption message; transmitting the encryption message over a telecommunication line; and decrypting the encryption message by the aforementioned message decryption method.

### BRIEF DESCRIPTION OF THE DRAWINGS

FIG. 1 is a block diagram of a hybrid encryption according to the present invention. In this figure, Z represents compression means, M represents removing means, ∥ represents combining means, Es represents symmetric-key encrypting means, Ep represents public-key encrypting means, and R64 represents radix-64 encoding.

FIG. 2 shows a non-compressible block in a deflate compression according to the present invention.

FIG. 3 shows a block compressed with static Huffman codes in the deflate compression according to the present invention.

FIG. 4 shows a block compressed with dynamic Huffman codes in the deflate compression according to the present invention.

FIG. 5 is a flow chart of the hybrid encryption.

FIG. 6 is a block diagram of PGP.

### DESCRIPTION OF THE PREFERRED EMBODIMENTS

A novel hybrid cryptosystem proposed in the present invention comprises a step of removing a part of data from a compressed message to be later encrypted with a symmetric cryptography so as to encrypt a session key and the removed data with a public key, which is an additional step that a conventional hybrid cryptosystem does not have.

In the novel hybrid algorithm, even if a symmetric encryption is broken, the message cannot be cracked. A basic idea of the improved hybrid cryptosystem is to reduce the amount of message to be encrypted with a symmetric algorithm and to encrypt a larger amount of message with a public key encryption. In order to increase security, a block structure of a public-key encryption and the DEFLATE compression algorithm are fully used in the following embodiment of the hybrid encryption according to the present invention.

In the embodiment of the present invention, examples of algorithms to be used for the novel hybrid cryptosystem include:

(1) public-key algorithm; RSA (Rivest-Shamir-Adleman; 1024 bits) as defined by PKCS #1 (public-key-cryptography-specifications)

(2) symmetric algorithm; AES (Advanced Encryption Standard) in CBC mode (128 bits)

(3) compression algorithm; GZIP (default)

The RSA of the above item number (1) is used as public-key encryption means in the following embodiment of the present invention, the AES in CBC mode of the item number (2) as symmetric encryption means, and the GZIP of the item number (3) as compression means. Further, in the embodiments, combining means simply combines two binary data.

Specifically, in the novel hybrid algorithm according to the embodiment of the present invention, (i) a message entered into a computer is converted into binary data; (ii) the converted message is compressed by compression means to generate a compressed message; (iii) a part of data is removed from the compressed message using removing means so as to generate lacked compression message and removed data. A method of removing a part of data from the compressed message using removing means will be described in detail in the following embodiment. Subsequently, (iv) the lacked compression message is encrypted by symmetric encryption means (AES in CBC mode) using a session key so as to generate an encryption message, and (v) the removed data and the binary data of the session key are combined using the combining means and then encrypted by the public-key encryption means (RSA) using a public key so as to generate an encryption block. Finally, (vi) a hybrid encryption message is generated by hybrid encryption means for combining the encryption message and the binary data of the encryption block by the combining means.

Further, in the embodiment of the present invention, the following decompression algorithm is used to decrypt and decompress the hybrid encryption message encrypted with the aforementioned algorithm to reconstruct the original message. First, (i) the aforementioned hybrid encryption message is decomposed into two binary data, the encryption message and the encryption block, by hybrid decryption means using decomposition means. As will be described below, information on the length of the encryption message is embedded in the encryption block as decryption information during the encrypting step, so that the hybrid encryption message can be decomposed by the hybrid decryption means. Next, (ii) the encryption block is decrypted by public key decryption means using an RSA-type secret key and then decomposed into the removed data and the binary data (128 bits) corresponding to the session key, and (iii) the encryption message is decrypted to recover the lacked compression message by symmetric key decryption means (AES in CBC mode) using the session key. Subsequently, (iv) the removed data is embedded in the lacked compression message by embedding means based on the decryption information to reconstruct the compressed message, and (v) the compressed message is decompressed by decompression means to reconstruct the original message. The decompression means used herein is an algorithm for decompressing the aforementioned compression algorithm (GZIP).

Further, the aforementioned encryption and decryption algorithms can be used in an encrypting or decrypting apparatus by recording programmed encryption and decryption algorithms in recording medium or by reading the aforementioned algorithms into a computer or the like from the recording medium. Thus, the encryption and decryption of a message can ensure secure message exchange over an insecure telecommunication line.

In order to propose a novel hybrid encryption, RSA Laboratories' Public Key Cryptography Standards #1 (PCSK#1), or a public key encryption format that is used in PGP, will be described below.

Public-Key Encryption Format

In a public-key cryptosystem such as RSA public-key cryptosystem, a message is written in big endian notation using multiple precision Integer, and is raised to a power. In fact, since the multiple precision Integers are limited by key length, the message must be divided by the key length, or byte length that is equal to or less than a value of modulus n. Like a symmetric-key cryptosystem, a public-key cryptosystem is a block encryption.

In order to prevent attack, random binary data called padding is inserted into a block encrypted with public key algorithm. For example, when a public key having a length of 1024 bits is used in public-key encryption and a session key having a length of 128 bits is used in symmetric encryption, more than 800-bit data is padding data.

In PGP, when a session key is encrypted with a public-key encryption, additional one byte is added as ID value for selecting a plurality of symmetric algorithms. The term “byte” used herein is exactly 8 bits. In PGP, data format of a 128-bit session key that is included in public-key encryption block is represented as follows:

D=ARG∥KEY (1)

D: data for encrypting session key with public-key encryption in PGP (136 bits)

ARG: ID value (8 bits) of symmetric-key encryption algorithm

∥: combining of binary data

KEY: session key (128 bits)

Let the data D represented by the above equation (1) be data of a public-key encryption block. A structure of a 1024-bit public-key encryption block is represented by the following equation (2) when an 128-bit session key is encrypted:

EB=00∥BT∥PS∥00∥D (2)

EB: one public-key encryption block (1024 bits)

00: a value of one byte (0)

∥: combining of binary data

BT: block type

PS: padding string (864 bits)

D: ID value and session key in symmetric algorithm (136 bits)

In the hybrid encryption of the present invention, padding data of the public-key encryption block defined by PKCS#1 can be reduced to a minimum of 8 bytes. The data removed from the above message is inserted in a space that is formed in the public-key encryption block by the reduction of the flexible padding data.

Next, in order to prevent the attack on a message even when a symmetric key is decrypted, characteristics of the Deflate compression algorithm are used in a method of removing a part of data from the message, namely, a method of removing header information, end-of-block value, and adjacent information thereof from each of the following three blocks (removing means). Deflate compressed data format that is used as a compression algorithm such as ZIP, ZLIB, and Gzip will be described as follows:

Deflate Compressed Data Format

Deflate compression is a completely recoverable compression, that is so-called a lossless compression, in which data is compressed using a combination of the LZ77 algorithm and the Huffman coding.

In the LZ77 compression, input data stream is treated as one byte character string, and such character strings are read from the front. When a duplicate string is found, it is compressed by being replaced with pointer information. The “pointer information” used herein includes a distance between the current occurrence and the previous occurrence and a length of the string to be restored. However, in order to ensure the effective replacement, the length must be 3 or more.

In Deflate compression, the LZ77 algorithm may use a reference to a duplicated string up to 256 bytes of length and 32 bytes of distance before. A simple example of the LZ77 compression will be shown below.

Compressible data

vvv

Blah blah blah!

LZ77-compressed data

Blah b[L=13, D=5]!

In the Huffman coding, original data stream is output as binary data by allocating the shortest bit length to the most frequent character. A Huffman code is instantaneous code that is uniquely decodable. Further, the Huffman code is characterized by having the minimum average code length in such a scheme that a one-to-one correspondence is established between codes and characters.

There are two types of Huffman codings; static Huffman coding and dynamic Huffman coding. In the static Huffman coding, characters are coded beforehand according to the frequencies of characters in a message. In the dynamic Huffman coding, characters are coded after checking the frequencies of characters in a message.

Therefore, in the dynamic Huffman coding, a Huffman table for showing a relation between an original character and a Huffman code should be added to binary data for decoding.

When input data is small, the above Huffman table reduces compressibility of a block compressed with dynamic Huffman codes. Therefore, a comparison is made between data compressed with dynamic Huffman codes and data compressed with static Huffman codes, and then the data of a shorter byte length is adapted.

In the deflate compression, after being compressed with LZ77, data is compressed with Huffman codes. Therefore, not only one-byte character called literal but also the length and the distance in the LZ77 compression are compressed with Huffman codes.

In order to achieve high compressibility, the Huffman code length is limited to a maximum of 15 bits. Further, the Huffman Table is also compressed with Huffman code when a dynamic Huffman coding is applied.

A simple example of Huffman coding when the frequencies of characters in a message are known is shown in Table 1.

TABLE 1

| ASCII | Frequencies | Huffman |
|---|---|---|
| A | 32 | 0 |
| B | 16 | 10 |
| C | 8 | 110 |
| D | 8 | 111 |

In the deflated compression, compressed data is composed of one or more blocks. There are three types of blocks: a non-compressed block, a block compressed with static Huffman codes, and a block compressed with dynamic Huffman codes.

The block compressed with static Huffman codes contains a Huffman table beforehand, and therefore header information is not added to the block. However, in the block compressed with dynamic Huffman codes, characters are Huffman-coded depending on their frequencies, so that the Huffman table must be added to the block as header information.

While the size of the non-compressible block is limited to 65,535 bytes or less, the blocks compressed with dynamic Huffman codes and static Huffman codes can be of any size.

While a block length is added to the non-compressible block as header information, it is not given to the blocks compressed with dynamic Huffman codes and static Huffman codes. Therefore, an end-of-block value is needed at the end of the latter two blocks.

Since both the blocks compressed with dynamic Huffman codes and static Huffman codes are not one-byte ordered, the end-of-block value prevents leading bit(s) of a next block and last bit(s) of a previous block from appearing in the same one byte.

In deflate compression, a compressed message is output in bytes. Therefore, when a last block contains less than 8 bits, a bit string of 0's is added to compensate for shortage of bits. Each block of compressed data begins with 3 header bits. First header bit indicates if this is the last block of the data set, and the next two bits indicates how the data are compressed.

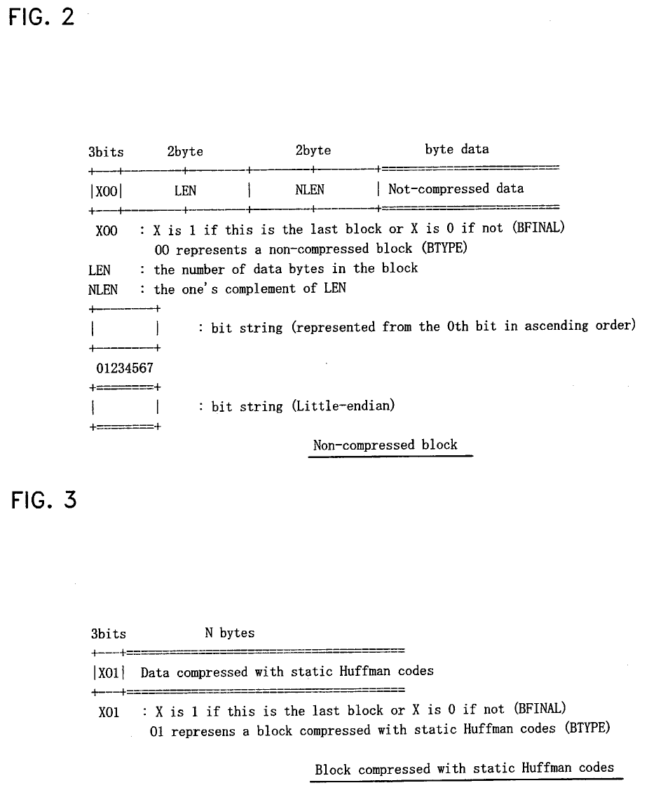

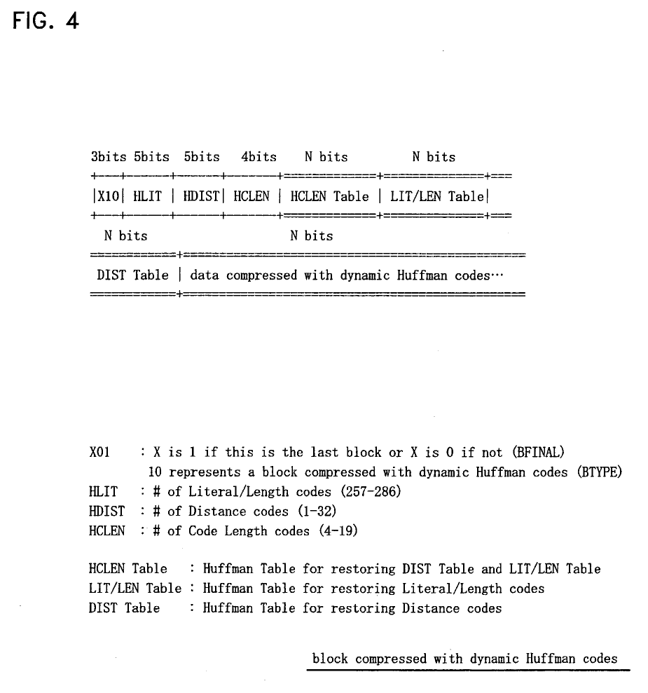

FIGS. 2 to 4 shows respective structures of three types of blocks in the deflate compression.

A Huffman table in a block compressed with dynamic Huffman codes, which is an important factor in a novel hybrid encryption algorithm proposed in the present invention, will be described below in detail.

First, the representation of literals and end-of block values and the representation of lengths and backward distances in the LZ77 algorithm will be described.

Consecutive values are assigned to the literals, end-of-block values, and distances, and they are compressed together using one Huffman table. These values are in a range between 0 and 285. Among them, the value 256 and the values 257 to 285, which exceed one byte, represent the end-of-block value and the length, respectively. The values 257 to 285 represent actual length possibly in conjunction with extra bits following the end-of-block value. The extra bits are allocated using a different table regardless of the compression with Huffman codes. The representations of the literal/end-of-block value in the deflate compression are shown in Table 2.

TABLE 2

| Value | Literal/end-of-block value |
|---|---|
| 0 | Literal (ASCII code) |
| • | |
| • | |
| • | |
| 255 | |
| 256 | End-of-block value |

The distance in the LZ77 compression is represented using the values 0 to 29. As in the case of the length, the values represent actual distance in conjunction with extra bits. The distance is compressed using a different Huffman table. The representations of the length and backward distance in the deflate compression are shown in Table 3 and 4.

TABLE 3

| Value | Extra bit | Length | Value | Extra bit | Length | Value | Extra bit | Length |
|---|---|---|---|---|---|---|---|---|
| 257 | 0 | 3 | 267 | 1 | 15, 16 | 277 | 4 | 67-82 |
| 258 | 0 | 4 | 268 | 1 | 17, 18 | 278 | 4 | 83-98 |
| 259 | 0 | 5 | 269 | 2 | 19-22 | 279 | 4 | 99-114 |
| 260 | 0 | 6 | 270 | 2 | 23-26 | 280 | 4 | 115-130 |
| 261 | 0 | 7 | 271 | 2 | 27-30 | 281 | 5 | 131-162 |
| 262 | 0 | 8 | 272 | 2 | 31-34 | 282 | 5 | 163-194 |
| 263 | 0 | 9 | 273 | 3 | 35-42 | 283 | 5 | 195-226 |
| 264 | 0 | 10 | 274 | 3 | 43-50 | 284 | 5 | 227-257 |
| 265 | 1 | 11, 12 | 275 | 3 | 51-58 | 285 | 0 | 258 |
| 266 | 1 | 13, 14 | 276 | 3 | 59-66 | | | |

TABLE 4

| Value | Extra bit | Distance | Value | Extra bit | Distance | Value | Extra bit | Distance |
|---|---|---|---|---|---|---|---|---|
| 0 | 0 | 1 | 10 | 4 | 33-48 | 20 | 9 | 1025-1536 |
| 1 | 0 | 2 | 11 | 4 | 49-64 | 21 | 9 | 1537-2048 |
| 2 | 0 | 3 | 12 | 5 | 65-96 | 22 | 10 | 2049-3072 |
| 3 | 0 | 4 | 13 | 5 | 97-128 | 23 | 10 | 3073-4096 |
| 4 | 1 | 5, 6 | 14 | 6 | 129-192 | 24 | 11 | 4097-6144 |
| 5 | 1 | 7, 8 | 15 | 6 | 193-256 | 25 | 11 | 6145-8192 |
| 6 | 2 | 9-12 | 16 | 7 | 257-384 | 26 | 12 | 8193-12288 |
| 7 | 2 | 13-16 | 17 | 7 | 385-512 | 27 | 12 | 12289-16384 |
| 8 | 3 | 17-24 | 18 | 8 | 513-768 | 28 | 13 | 16385-24576 |
| 9 | 3 | 25-32 | 19 | 8 | 769-1024 | 29 | 13 | 24577-32768 |

Further, if dynamic Huffman codes are lexicographically allocated, the dynamic Huffman codes can be represented simply using code lengths.

Specifically, in the respective Huffman tables, the literal/length and the backward distance can be represented by allocating the Huffman code lengths ranging from 0 to a maximum value. In the deflate compression, the amount of information of the Huffman table is reduced by using this method.

Table 5 shows a simple example where the Huffman codes can be represented simply using code lengths when the Huffman codes are lexicographically allocated. To make the explanation simple, input data are represented as the alphabet from A to I.

TABLE 5

| ASCII | Code length | Lexicographic order Huffman code |
|---|---|---|
| A | 3 | 010 |
| B | 0 | — |
| C | 3 | 011 |
| D | 3 | 100 |
| E | 3 | 101 |
| F | 2 | 00 |
| G | 4 | 1110 |
| H | 4 | 1111 |
| I | 3 | 110 |

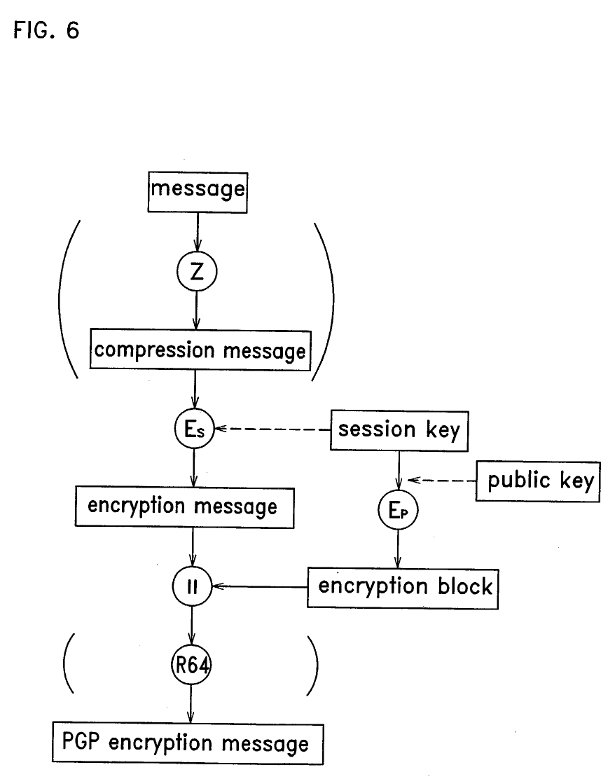

In the Huffman table for the literal/length, code lengths of the Huffman codes are generally represented as “0”. Although a maximum value of the code length is 15, the values of 16 to 18 are further added to repeat a code length. Representations of code length are shown in FIG. 6.

TABLE 6

| | Code length/Representation of data to be added to code |
|---|---|
| Value | length |
| 0 | 0-15: Represent code lengths of 0-15 |
| • | (0 does not appear in input data and indicates |
| • | that no Huffman code is allocated.) |
| • | |
| • | |
| • | |
| 15 | |
| 16 | 16: Copy the previous code length 3-6 times |
| | (The next 2 bits indicate repeat length.) |
| 17 | 17: Repeat a code length of 0 for 3-10 times. |
| | (3 bits of length) |
| 18 | 18: Repeat a code length of 0 for 11-138 times. |
| | (7 bits of length) |

To achieve greater compressibility, the Huffman tables for the literal/length and the backward distance are further compressed using Huffman codes. In other words, Huffman cords are prepared to represent 19 kinds of code lengths, and the code lengths are represented using 3 bits. Such a set of 3 bits is taken as a Huffman table.

However, unlike in the other two Huffman tables, Huffman codes in the Huffman table for code lengths is arranged in order of frequencies not in ascending order from 0 to a maximum value.

In the Huffman table for code lengths, the Huffman codes having a code length of 3 bits are in the order: 16, 17, 18, 0, 8, 7, 9, 6, 10, 5, 11, 4, 12, 3, 13, 2, 14, 1, and 15.

All the values are not always registered in the above three Huffman tables. The frequencies of the values decrease with the order of the Huffman codes.

Since the value subsequent to HLIT/HDIST/HCLEN value to the maximum value are not used, they are not included in the Huffman table.

In order to print out the compressed data as a sequence of bytes, the data elements are packed into bytes starting with the least-significant bit of the byte. However, Huffman codes are packed starting with the most-significant bit of the code so as to pack them at a high speed.

As stated above, the block compressed with dramatic Huffman codes can achieve a very high compressibility. Therefore, it is obvious that the block compressed with dynamic Huffman codes is generally selected in the deflate compression when input data is large.

Accordingly, using the nature of the deflate compression algorithm described above, a part of data is removed so as not to crack a message even if a symmetric key encryption is broken. Specifically, there is adopted a technique for removing header information, end-of-block value, and adjacent information thereof from each of the aforementioned three kinds of blocks (removing means).

The most effective technique for making it difficult to crack the compressed message is to remove header information. This is because it is the most natural to select a block compressed with dynamic Huffman codes in the deflate compressed data format and because it is almost impossible to decrypt a message when header information, or Huffman table, is removed form the block compressed with dynamic Huffman codes.

In addition to the header information, the end-of-block value and the adjacent information are also removed. This is effective when the attackers do not know the contents of the Huffman table. As such, the data to be encrypted with symmetric key encryption becomes substantially completely random binary data.

Further, although the header information and the end-of-block value are binary data, they are removed in bytes because paddings are constructed in bytes in the public-key encryption. This makes it possible to perform the hybrid encryption/decryption at a high speed.

The number of blocks encrypted with the public-key encryption may be plural, because the addition of several public-key encryption steps does not seem to lower the encryption/decryption speed very much. In addition, a plurality of blocks encrypted with the public-key encryption makes it possible to secure a sufficient amount of information to be removed from all the blocks so as to achieve higher security in which little information in blocks cannot be broken.

Finally, after determining the number of blocks encrypted with the public-key encryption and the upper limit of information to be removed, a step of removing a random amount of information is performed in the hybrid encryption.

In other words, not a maximum amount of information is removed. This step makes it more difficult to crack a message.

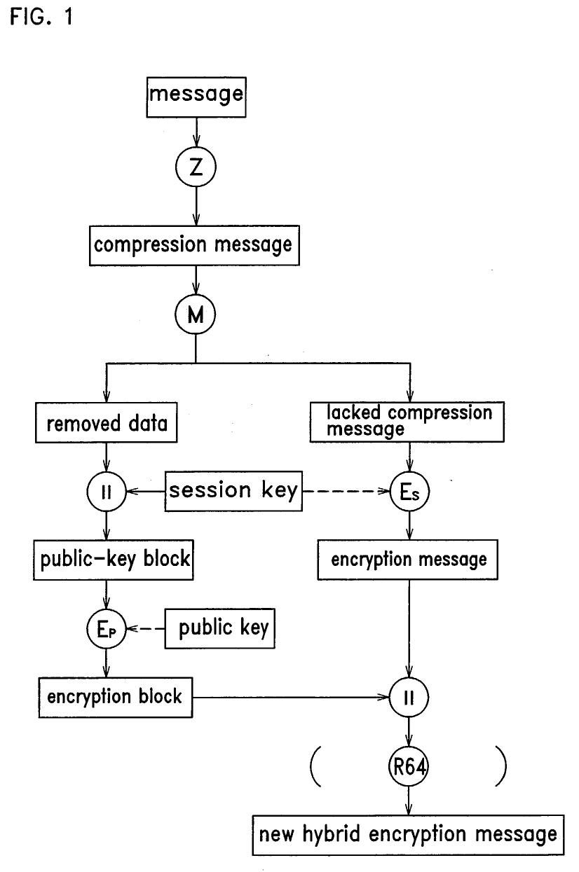

A novel hybrid encryption algorithm is shown in FIG. 1, and an embodiment of effectively performing the aforementioned algorithm will be described as follows. In FIG. 1, Z represents compression means, M represents removing means, ∥ represents combining means, Es represents symmetric-key encrypting means, Ep represents public-key encrypting means, R64 represents radix-64 encoding, a bold line represents a message flow, and a dotted line represents an encryption using each key.

(A) Novel Hybrid Encryption Algorithm

In PGP, an attribute and length of each packet and algorithms are identified using a packet system. However, in the hybrid encryption according to the present invention, (1) even a message obtained by decrypting a block encrypted with symmetric encryption using a right session key should be so designed that it is random binary data, and (2) the novel hybrid encryption algorithm should be so designed that the upper limit of the amount of information to be protected by a public key is as high as possible.

For the aforementioned reasons, in the present invention, the packet system in which an identifier is used is not adopted, and the algorithms are not sorted out.

The ciphertext encrypted with hybrid encryption according to the present invention is composed of one or more public-key blocks encrypted with RSA and a symmetric-key block encrypted with AES. Therefore, an identification problem can be solved by converting the aforementioned blocks separately into ASCII Armour.

Since several kinds of data are encrypted in a public-key block, the identification of data is necessary. However, by defining a data format given to the public-key block, an identifier is not needed. The data format to be used is shown in the following equations (3) and (4).

In PGP, a compression algorithm is not necessarily used. However, in the hybrid encryption according to the present invention, it is preferable to use a compression algorithm. This is because however small the message is, Gzip always uses either one of a block compressed with dynamic Huffman codes and a block compressed with static Huffman codes.

In deflate compression of PGP, a buffer value that corresponds to the size of a sliding window used in LZ77 compression is limited to one fourth of a default buffer value. However, this limitation considerably lowers compressibility, so that it is not adopted in the present invention.

In order to determine which data is removed, it is necessary to obtain the information about where the header information begins and where an end-of-block value exists for each deflate compressed block. However, scanning the Huffman-coded output all over again to detect the end of the block requires double the labor, so that the encryption/decryption process takes more time.

This problem can be solved by previously adding to Gzip a function of outputting the size of each deflate-compressed block.

(B) Using Public-Hey Encryption a Plurality of Times

In RSA encryption to be used in this embodiment, a key length is only 1024 bits. However, in deflate compressed data, the maximum size of the header information of the block compressed with dynamic Huffman codes is 700 bits or more, although it depends on the kinds and frequencies of characters to be used.

A plurality of blocks are used for outputting the deflate compressed data. Where the amount of information of the message is large and a public-key block encrypted with RSA is regarded as one block, the amount of data to be removed from each deflate compressed data is small.

Therefore, in order that a sufficient amount of information in each block is protected with RSA, when a plurality of deflate compressed blocks are prepared, it is preferable to prepare as many public-key blocks encrypted with RSA as deflate compressed blocks.

However, even if the public-key encryption is performed many times, this does not exert a great influence on the encryption and decryption speeds in the hybrid encryption, because it is determined every 32 k bits in deflate compression where the data is effectively divided into blocks. For example, text data to be exchanged by e-mail is divided into three blocks at most. Even considerably large input data is divided into less than 10 blocks.

(c) Removal of Deflate Compressed Message

When a key length is 1024 bits in RSA encryption, maximum data size in one block is 936 bits (117 bytes). However, 4 bytes are used for decryption, so that the maximum data size to be removed is 113 bytes.

Further, in order to make the amount of information to be removed somewhat random, a random number ranging from 57 to 113, which is about half of the maximum value, may be generated and used as the number of bytes to be removed from every public-key block. However, it is necessary that the first public-key block is further shortened by 16 bytes (128 bits) for adding a session key.

Further, in order to make data encrypted with symmetric key look like random binary data, the data is composed of blocks from which header information and end-of-block value are removed. Therefore, decryption information for completely restoring the removed data is needed for decryption.

This can be solved by using the length of the blocks from which header information and end-of-block value are removed as decryption information. The decryption information on the length of the blocks is provided as a 4-byte unsigned integer value. That value may be converted into little endian and prefixed to the data which is to be given to the public-key block.

The reason why the length of the remaining block is represented as a 4-byte value is because a 2-byte value can only represent the block length of 65535 bytes at most but the 4-byte value can represent the block length of up to about 4 Gbytes. In other words, while a deflate compressed block only has a length of integral multiples of 32 K bits at most, the remaining block has a length of up to 4 Gbytes.

(D) Method of Identifying Data Without Using an Identifier in One Public-Key Block

In order to identify data, the length of footer information representing an end-of-block-value and adjacent information thereof is limited to 10 bytes. This limitation makes it possible to exactly distinguish header information from footer information in the decryption step.

Therefore, a format of data to be given to a public-key block can be composed of header information, 10-byte footer information, and 4-byte information on the length of a block from which the header information and the footer information are removed. To a first public block is further added a 16-byte session key.

If a block length of data to be randomly removed is 720 bits, data format to be given to a first public-key block is shown in an equation (3) and data format to be given to a second or subsequent block is shown in an equation (4).

D=LENGTH∥HEADER∥FOOTER∥KEY (3)

D: data to be given to the first public-key block (720 bits)

LENGTH: length of a remaining deflate compressed block (32 bits)

∥: combining of binary data

HEADER: header information of the deflate compressed block (480 bits)

FOOTER: information including an end-of-block value of the deflate compressed block (80 bits)

KEY: session key (128 bits)

D=LENGTH∥HEADER∥FOOTER (4)

D: data to be given to the second or subsequent public-key blocks (720 bits)

∥: combining of binary data

LENGTH: length of a remaining deflate compressed block (32 bits)

HEADER: header information of a deflate compressed block (608 bits)

FOOTER: information including an end-of-block value of the deflate compressed block (80 bits)

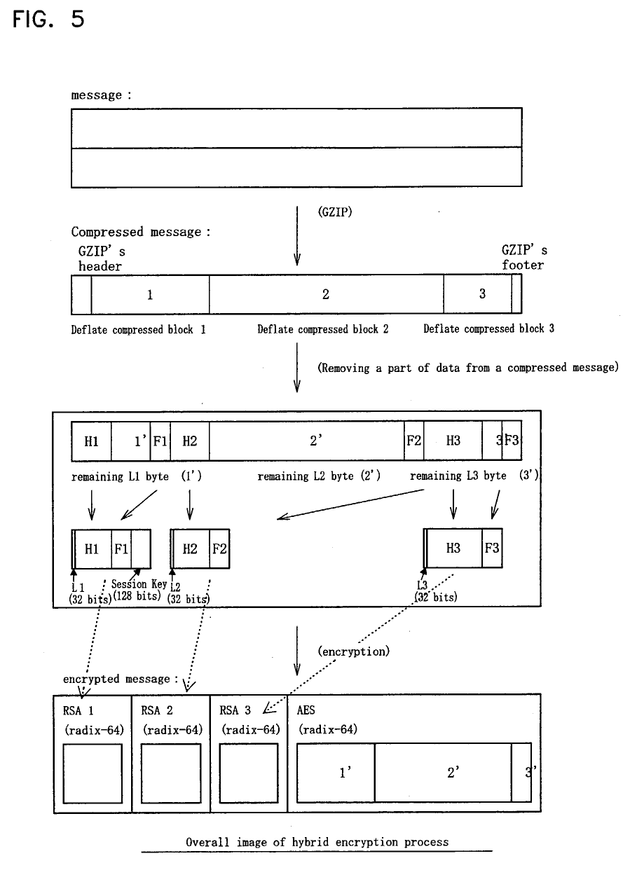

FIG. 5 shows a flow chart of a hybrid encryption process according to the present invention. In this figure, three blocks are deflate compressed.

(E) Public Key Encryption

In the aforementioned embodiment, the number of the public-key blocks is the same as that of the deflate compressed blocks. However, the number of public-key block may be one if the public key length is sufficiently long.

The length of a key used in a conventional hybrid encryption is in a range of about 1024 to 4096 bits. However, computational complexity required for attacking a ciphertext encrypted with a public key of such length is much smaller than that required for discovering a session key in a brute force attack.

Considering a trial calculation of the computational complexity to be required for RSA attack and the future of the public-key encryption, the length of a public key is preferably at least 8192 bits or more.

In the aforementioned embodiment, RSA is used as a public key encryption scheme. However, a public-key encryption algorithm has no effect on the hybrid encryption of the present invention. Therefore, encryption algorithms such as Elgamal encryption algorithm and elliptic curve algorithm may be used.

Therefore, by using a next-generation encryption algorithm such as a elliptic curve algorithm and quantum encryption algorithm instead of the conventional public-key encryption algorithm, the problem of too long length of the key is to be solved. Thus, the reliability of the hybrid encryption of the present invention is further increased.

For example, by adding the algorithm for removing a part of a message according to the present invention to a quantum encryption scheme, more reliability can be achieved than a conventional quantum encryption scheme. Since the quantum encryption is used only for transmitting a key, it can be regarded as the same scheme as a conventional hybrid cryptosystem in which secure message exchange is secured only using a symmetric key (session key).

(F) Symmetric Key Encryption

Like the aforementioned public key encryption, the hybrid cryptosystem of the present invention is not also influenced by a conventional symmetric algorithm. In the hybrid cryptosystem of the present invention, in order to attack data encrypted with a symmetric key, every possible session key must be tried in a brute force attack to find the actual session key, regardless of the symmetric algorithm. Even if the actual session key is found, the data decrypted with that session key is substantially completely random binary data.

Even if the session key is identified, removed data and the position thereof must be identified. After all, every possible public key must be tried in a brute force attack.

Accordingly, the hybrid cryptosystem of the present invention makes it possible to send a message without protecting it by a symmetric key encryption. As far as a sufficiently long key is selected as a public key, a message can be securely exchanged without performing double encryption.

(G) Compression Algorithm

As a compression algorithm, an algorithm in which no deformation occurs when the compressed data is decompressed must be used in this invention.

In the aforementioned deflate compression, Huffman codes are used. In this case, the frequency of occurrence of each character in a message is an important factor.

Therefore, algebraic codes may be used instead of Huffman codes. The algebraic code is a compression algorithm in which a probability of occurrence is represented as a decimal fraction ranging from 0 or more to less than 1 and the whole message is encoded using the decimal fraction. In this algorithm, the decimal fraction itself is used as a code.

When the algebraic code is used instead of Huffman code, the reliability of the hybrid encryption of the present invention is further increased.

The algebraic code is very compatible with the hybrid encryption of the present invention. One reason is that the algebraic code can compress data at higher speed and at higher compressibility than the Huffman code. Another reason is that the algebraic code has a characteristic that original characters are not represented as particular bits.

This characteristic of the algebraic code allows the binary data that is encrypted with a symmetric key to be further randomize.

As stated above, in the hybrid cryptosystem of the present invention, in order to attack data encrypted with a symmetric key, every possible session key must be tried in a brute force attack to find the actual session key, regardless of the symmetric algorithm. Even if the actual session key is found, the data decrypted with that session key is substantially completely random binary data. Furthermore, since the symmetric key is a one-time-only random session key, every possible key must be tried in a brute force attack to find the actual key, regardless of the symmetric algorithm.

Even if the session key is identified, removed data and the position thereof must be identified. After all, every data encrypted with a public key must be tried in a brute force attack.

The computational complexity required for attacking data encrypted with a symmetric key is an order of magnitude larger than that required for attacking data encrypted with a public key. In a conventional hybrid encryption, the number of session keys that are tried in a brute force attack is 2¹²⁸ (2²⁵⁶ at the maximum). However, in the hybrid encryption according to the present invention, if n blocks of data are encrypted with a public key, the number of session keys that are tried in a brute force attack reaches the value expressed by the following equation.

$${\sum }_{i = 57}^{113} {2}^{8 i n} = ( {2}^{8 \times 57 n} + {2}^{8 \times 58 n} + ⋯ + {2}^{8 \times 113 n} )$$

Further, this hybrid encryption has an advantage in that the amount of data (byte) to be removed increases dramatically with the size of a key to be used in the public-key encryption. Therefore, it becomes more difficult to attack the data encrypted with a symmetric key.

Thus, attacks on the data encrypted with a symmetric key is not feasible in the hybrid cryptosystem of the present invention.

The development of symmetric-key encryption may be no more necessary for at least the hybrid encryption of the present invention, because it is impossible to decrypt even binary data encrypted with a symmetric key. Thus, the hybrid encryption algorithm of the present invention makes it possible to securely transmit even such a message that is not encrypted with a symmetric key.

However, if a message is encrypted using a symmetric key having a size of 128 bits or more, it becomes secure enough against all the conceivable attacks such as a brute force attack and may be very effectively used for randomization.

As clear from the above, the hybrid cryptosystem according to the present invention is much more excellent system than a conventional hybrid cryptosystem in which the length of a symmetric key is simply extended.

There has thus been shown and described a novel encryption and decryption program which fulfils all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A message encryption program for causing a computer to function as:
compression means for compressing binary data;
combining means for combining a plurality of binary data;
removing means for removing a part of data from a compression message obtained by compressing a message entered into the computer by the compression means so as to generate a lacked compression message and removed data;
symmetric key encryption means for encrypting the lacked compression message with a symmetric algorithm using a session key to generate an encryption message;
public key encryption means for encrypting the removed data and the session key with a public key encryption algorithm using a public key by combining them by the combining means so as to generate an encryption block; and
hybrid encryption means for combining the encryption message and the encryption block by the combining means to generate a hybrid encryption message.

2. A program for decrypting the hybrid encryption message generated by the encryption program according to claim 1, said program causing a computer to function as:
decompression means for decompressing the binary data compressed by the compression means;
decomposition means for decomposing the binary data combined by the combining means into the plurality of binary data;
hybrid decryption means for decomposing the hybrid encryption message into the encryption message and the encryption block by the decomposition means;
public key decryption means for decrypting the encryption block with a public key decryption algorithm using a secret key and then decomposing it into the removed data and the session key by the decomposition means;
symmetric key decryption means for decrypting the encryption message into the lacked compression message with a symmetric key decryption algorithm using the session key; and
embedding means for embedding the removed data in the lacked compression message to restore the compression message,
wherein the compression message is decompressed by the decompression means so as to decrypt it into the message entered into the computer.

3. An apparatus for encrypting a message comprising:
compression means for compressing binary data;
combining means for combining a plurality of binary data;
removing means for removing a part of data from a compression message obtained by compressing a message entered into the apparatus by the compression means so as to generate lacked compression message and removed data;
symmetric key encryption means for encrypting the lacked compression message with a symmetric algorithm using a session key to generate an encryption message;
public key encryption means for encrypting the removed data and the session key with a public key encryption algorithm using a public key by combining them by the combining means so as to generate an encryption block; and
hybrid encryption means for combining the encryption message and the encryption block by the combining means to generate a hybrid encryption message.

4. An apparatus for decrypting the hybrid encryption message generated by the apparatus according to claim 3 into the message entered into the apparatus, comprising:
decompression means for decompressing the binary data compressed by the compression means;
decomposition means for decomposing the binary data combined by the combining means into the plurality of binary data;
hybrid decryption means for decomposing the hybrid encryption message into the encryption message and the encryption block by the decomposition means;
non-public key decryption means for decrypting the encryption block with a public key decryption algorithm using a secret key and then decomposing it into the removed data and the session key by the decomposition means;
symmetric key decryption means for decrypting the encryption message into the lacked compression message with a symmetric key decryption algorithm using the session key; and
embedding means for embedding the removed data in the lacked compression message to restore the compression message,
wherein the compression message is decompressed by the decompression means so as to decrypt it into the message entered into the apparatus.

5. A method for encrypting a message using a computer having: compression means for compressing binary data; and combining means for combining a plurality of binary data, comprising the steps of:
removing a part of data from a compression message obtained by compressing a message entered into the computer so as to generate lacked compression message and removed data;
encrypting the lacked compression message with a symmetric algorithm using a session key to generate an encryption message;
encrypting the removed data and the session key with a public key encryption algorithm using a public key by combining them by the combining means to generate an encryption block; and
combining the encryption message and the encryption block by the combining means to generate a hybrid encryption message.

6. A method for decrypting the hybrid encryption message by the method according to claim 5 using a computer having: decompression means for decompressing the binary data compressed by the compression means; and decomposition means for decomposing the binary data combined by the combining means into the plurality of binary data, comprising the steps of:
decomposing the hybrid encryption message into the encryption message and the encryption block;
decrypting the encryption block with a public key decryption algorithm using a secret key and then decomposing it into the removed data and the session key;
decrypting the encryption message into the lacked compression message with a symmetric key decryption algorithm using the session key; and
embedding the removed data in the lacked compression message to restore the compression message,
wherein the compression message is decompressed to decrypt it into the message entered into the computer.

7. A computer readable recording medium for recording the program according to claim 1 or 2.

8. A method for ensuring secure message exchange over an insecure telecommunication line, comprising the steps of:
encrypting a message using the method according to claim 5 to generate an encryption message;
transmitting the encryption message over a telecommunication line; and
decrypting the encryption message by the method according to claim 6.
